(19) United States
(12) Patent Application Publication
(10) Pub. No.: US 2009/0123852 A1
(43) Pub. Date: May 14, 2009

(54) Hard-material object comprising visional color-varying surface

(76) Inventor: Min San Huang, Taipei County (TW)

Correspondence Address: BACON & THOMAS, PLLC, 625 SLATERS LANE, FOURTH FLOOR, ALEXANDRIA, VA, 22314-1176, US

(21) Appl. No.: 11/979,985

(22) Filed: Nov. 13, 2007

(51) Int. Cl. G03C 1/00

(52) U.S. Cl. 430/2

(57) ABSTRACT

A hard-material object comprising a visional color-varying surface comprises a hard-material carrier and a pattern disposed on the surface of the hard-material carrier. The pattern comprises a plurality of multi-color pellets to compose a picture. Each of the multi-color pellets comprises the distinct coloring regions distinguishable by the eyes so that a viewer can obtain different color-varying visional feeling from the pattern when the hard-material carrier is resting and looked at from different view angles.

### BACKGROUND

1. Related Field

The present invention relates to a pattern, more particularly to a pattern attached to a daily supply with an observable surface in a fixed shape, and especially to a pattern that generates a color-varying effect due to different view angles looked at by a viewer.

2. Prior Art

It is seen everywhere that a pattern is attached to an object to increase the esthetic feeling of the object. For example, the designed patterns are adopted for various home furniture textiles, clothing texture by embroidering or printing on the surfaces thereof. It not only increases the esthetic feeling of the products in decoration, but also increases the purchasing desire from customers.

For accentuating the visional effect of the attached patterns on the surfaces of the products, how to select the colors, materials, and methods of manufacturing for the patterns is very important. Therefore, many providers are dedicated to the research for accentuating the visional effects of the patterns, and offer new products to satisfy the customers' need.

As these patterns are provided by a static design for the daily supplies, such as printing or transferring patterns on the cups, ceramic tiles, or cellular phones, hard material paper sheet, plastic sheet and so on, the shapes and colors of the patterns when they are looked at from different view angles only provide a difference in angle wise. Patterns themselves cannot get rid of the impression of rigidness in vision. Although the providers have been trying to improve, there is still no ideal solution.

### SUMMARY

In view of that the patterns attached to the surfaces of the products can only provide rigid visional effect, the object of present invention is to provide patterns that can generate vivid and various visional effects.

According to the object mentioned above, the present invention provides a pattern that can be applied to the various daily supplies with fixed shapes and observable surfaces. The color-varying visional feeling can be obtained from the pattern through the observations of different view angles.

The embodiment to accomplish the object mentioned above is the following:

The present invention is a designed observable pattern attached on the surface of a hard-material carrier. The pattern comprises a plurality of multi-color pellets to compose a picture. Each of the multi-color pellets comprises the distinct coloring regions distinguishable by the eyes so that a viewer can obtain different color-varying visional feeling from the pattern when the hard-material carrier is resting and looked at from different view angles.

The multi-color pellet comprises a bar-shaped or semi-sphere appearance, but not limited.

The coloring region of the multi-color pellet can be divided into at least two or more color districts with different colors respectively.

The following embodiments describe the features and the advantages of the present invention in detail. The content of the embodiments enable a person skilled in the art to understand and accomplish the features of the present invention. And according to the disclosed specification, claims, and drawings, any person skilled in the art can easily understand the related objects and advantages of the present invention.

### BRIEF DESCRIPTION OF THE DRAWINGS

FIG. 1 is the three-dimension view of the embodiment of the present invention.

FIG. 2 is the floor plane of the embodiment of the present invention.

FIG. 3 is the enlarged partial floor plane of the disclosed pattern of FIG. 2.

FIG. 4 is the enlarged partial three-dimension view of the disclosed pattern of FIG. 2.

FIG. 5 is the three-dimension diagram of the multi-color pellets of the present invention to compose the pattern.

FIG. 6 is another three-dimension appearance and the bird's eye view of the multi-color pellets of the present invention to compose the pattern.

FIG. 7 is another embodiment of the disclosed multi-color pellets of the present invention to compose the pattern.

FIG. 8 is another embodiment of the disclosed multi-color pellets of the present invention to compose the pattern.

FIG. 9 is the diagram to illustrate a viewer observes from different view angles.

### DETAILED DESCRIPTION OF THE PRESENT INVENTION

To further understand the objects, structure, features, and function of the present invention, the embodiments are accompanied to describe in detail as the following.

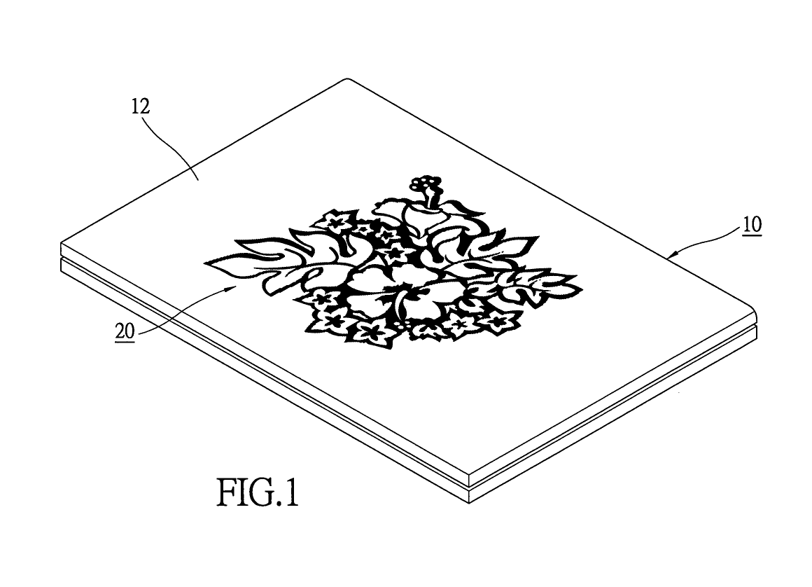

Referring to FIG.1, the present invention comprises a hard-material carrier 10 and a pattern 20 disposed on the surface of the surface of the carrier 10. The carrier of the present invention can be the illustrated notebook computer, and also the various daily supplies, such as cups (tableware), tiles (architecture material), and cell phone (electronics). In addition, the contour of the style of the pattern 20 is not limited in the specific style shown in the figure. The pattern 20 can be printed or transferred, or by any other manufacture means, onto the surface of the hard-material carrier 10.

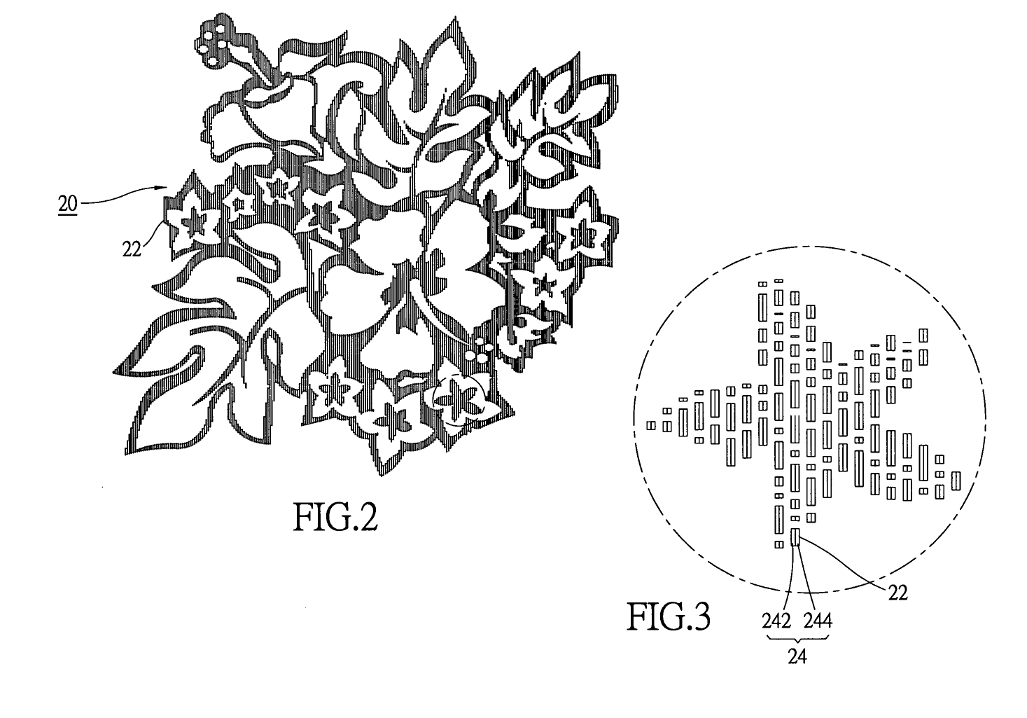

FIG. 2 illustrates a floor plane of the pattern attached on the surface of the top cover of a notebook computer. FIG. 3 illustrates the diagram of the enlarged partial pattern. As shown in the figures, the pattern 20 disposed on the surface 12 of the top cover comprises a plurality of the multi-color pellets 22 to compose the picture. Each of the multi-color pellets 22 comprises the distinct coloring regions 24 distinguishable by the eyes.

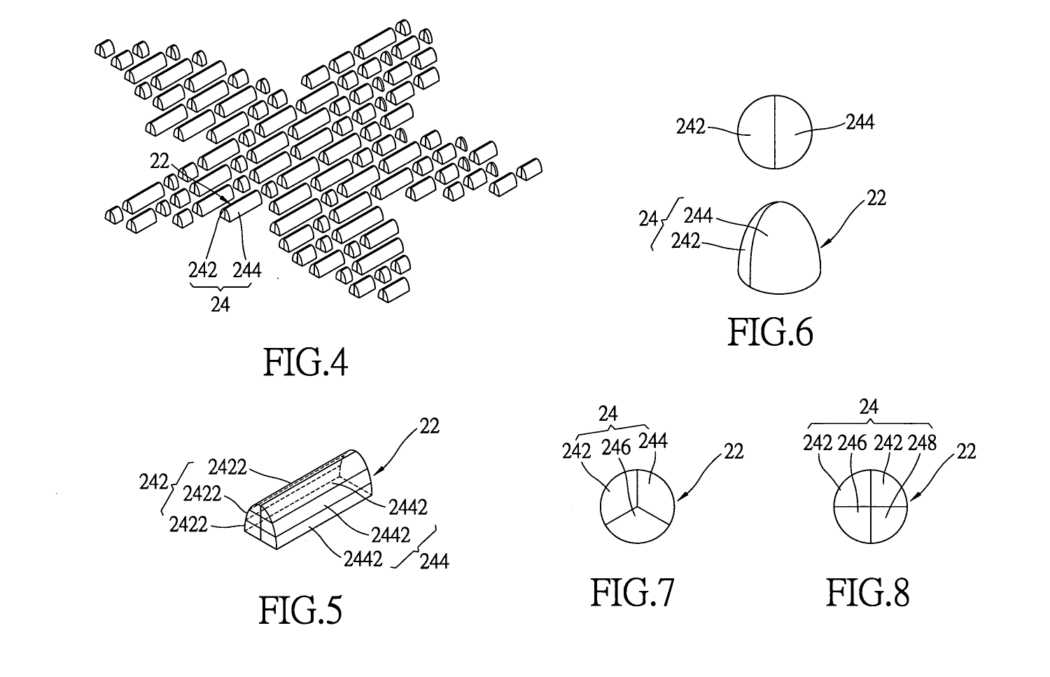

Referring to FIG. 4 at the same time, it is the corresponding three-dimension view of the partial pattern of FIG. 3. From the observation of the figure, the appearance of the each of the multi-color pellets 22 is bar-shaped, and the coloring region 24 of each of the multi-color pellet 22 is divided into at least tow or more color districts 242, 244 with different colors respectively.

The two color districts 242, 244 can be two distinct colors distinguished by tone, luminance, chroma, or combination thereof. In an embodiment, the coloring region 24 of the multi-color pellets 22 can adopt non-black-and-white color districts 242, 244. For example, the surface color of the color district 242 is red and the surface color of the other color district 244 is green.

Besides, the coloring regions 24 of the multi-color pellets 22 can adopt a combination of the colorful or non-colorful color districts 242, 244. For example, the surface color of the color district 242 is red, and another surface color of the color district is black, white, or any gray level between the black and white.

In addition, the coloring regions 24 of the multi-color pellets 22 can adopt gradient, colorful color districts 242, 244. For example, the surface color of the color district 242 is the gradient red and the surface color of the other color district 244 is the gradient green.

Moreover, the coloring regions 24 of the multi-color pellets 22 can adopt the color districts 242, 244 comprising small color bodies 2422, 2442 with various colors respectively as shown in FIG. 5.

According to the mentioned above, the adoption of the colors of the coloring region 24 can be a combination of separate non-black-and-white colors, black-and-white colors including gray level, gradient colors in non-black-and-white color, and different color bodies 242, 244.

Referring to FIG. 6, in an embodiment, the appearance of the multi-color pellets 22 for composing the pattern 20 can be semi-sphere as shown in the figure.

As the mentioned above, the coloring region 24 of the multi-color pellet 22 has to be divided into at least two or more color districts 242, 244 with different colors respectively. FIG. 7 and FIG. 8 illustrate the variation that the multi-color pellet 22 comprises three equally area-divided color districts 242, 244, 246 and four equally area-divided color districts 242, 244, 246, 248 respectively.

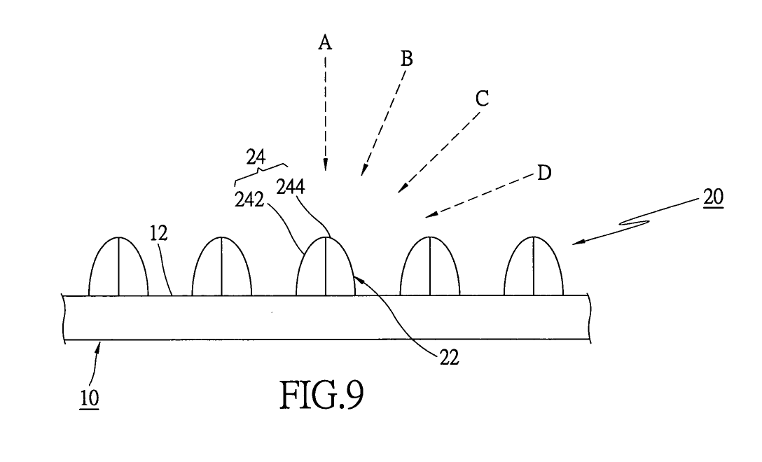

Referring to FIG. 9, it is the lateral section view of the multi-color pellets 22 composing the pattern 20 disposed on the surface 10 of the top cover of the notebook computer 10. When a viewer takes a look at the multi-color pellet 22 from the direction of the arrowhead A, direction of the arrowhead B, direction of the arrowhead C, and direction of the arrowhead D as shown in the figure, the observed surface colors of the multi-color pellet 22 are different because the view angles are different. For example, the observed multi-color pellet 22 from the view angle of the direction of the arrowhead A comprises the whole color district 242 and to top surface of the color district 244. But with the increasing of the slop of the view angles, the observed ratio of the tow color districts 242, 244 is changed because the shielded level of the coloring region 24 is changed. For example, the area of the color district 242 of the multi-color pellet 22 observed from the direction of the arrowhead B is bigger than from the direction of the arrowhead C. And from the direction of the arrowhead D, the observed multi-color pellet 22 comprises the surface color of the color district 242, but almost nothing of the color district 244.

To sum up, the present invention is a pattern 20 comprising a plurality of multi-color pellets 22 to compose the picture. The multi-color pellet 22 comprises distinct coloring regions distinguishable by the eyes so that a viewer can obtain different color-varying visional feeling from the pattern when the hard-material carrier is resting and looked at from different view angles.

Although the present invention is disclosed as the above, but it is not in tended to limit the present invention. The change and modification without departing from the spirit and scope of the present invention are within the claimed scope of the present invention. Please refer to the attached claims for the claimed scope of the present invention.

What is claimed is:

1. A hard-material object with a color-varying surface in vision, comprising:
a hard-material carrier comprising an observable surface in a fixed shape; and
a pattern disposed on the surface, wherein the pattern comprises a composition of a plurality of multi-color pellets and each of the multi-color pellets comprises a coloring region for distinguishing a combination of colors in vision, whereby a plurality of the multi-color pellets generates a varying effect in vision, due to a change of a view angle accompanying with a color variation of the coloring region, when the pattern is looked at from a plurality of different angles.

2. The hard-material object with a color-varying surface in vision according to claim 1, wherein the hard-material object comprises a daily supply.

3. The hard-material object with a color-varying surface in vision according to claim 1, wherein each of the multi-color pellets comprises a bar-shaped appearance.

4. The hard-material object with a color-varying surface in vision according to claim 1, wherein each of the multi-color pellets comprises a semi-sphere-shaped appearance.

5. The hard-material object with a color-varying surface in vision according to claim 1, wherein the coloring region comprises two distinct areas with different colors.

6. The hard-material object with a color-varying surface in vision according to claim 5, wherein an area of the two distinct areas comprises a non-black-and-white color.

7. The hard-material object with a color-varying surface in vision according to claim 5, wherein an area of the two distinct areas comprises a black color, or a white color, or a color in a gray level.

8. The hard-material object with a color-varying surface in vision according to claim 5, wherein an area of the two distinct areas comprises a gradient-colored region.

9. The hard-material object with a color-varying surface in vision according to claim 5, wherein an area of the two distinct areas further comprises a plurality of color districts with different colors.
